(19) United States
(12) Patent Application Publication
(10) Pub. No.: US 2021/0222501 A1
(43) Pub. Date: Jul. 22, 2021

(54) Vacuum Manifold Assembly

(71) Applicant: Mark Eilam, Morgantown, WV (US)

(72) Inventor: Mark Eilam, Morgantown, WV (US)

(21) Appl. No.: 16/747,176

(22) Filed: Jan. 20, 2020

(51) Int. Cl. E21B 17/18; E21B 43/18

(52) U.S. Cl. CPC E21B 17/18; F16L 41/03; E21B 43/18

(57) ABSTRACT

A vacuum manifold assembly includes a vacuum manifold that includes a body defining an interior space of the vacuum manifold, an input tube and a plurality of output tubes. The input tube is coupled to the body and is in fluid communication with the interior space. Each of the plurality of output tubes is coupled to the body and is in fluid communication with the interior space. In this way the input tube is in fluid communication with each of the plurality of output tubes. The vacuum manifold is comprised of an oil resistant material to resist being degraded by crude oil. Additionally, the vacuum manifold is comprised of a rigid material to resist being deformed by vacuum pressure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to manifold devices and more particularly pertains to a new manifold device for fluidly coupling a plurality of vacuum hoses to a vacuum pump.

### Description of Related Art Including Information Disclosed Under 37 CFR 1.97 and 1.98

The prior art relates to manifold devices. The prior art discloses a fluid valve that includes cam locking portions. The prior art discloses a fluid servicing device that includes a manifold body and a pair of pump openings. The prior art discloses a fluid recovery device that includes a recovery tank and a suction nozzle. Additionally, the prior art discloses a surface cleaning device that includes a pair of openings, each having a profile shaped to conform to unusual surfaces. The prior art discloses a fluid tank that includes an inlet, an outlet and a plurality of fluid baffles in the interior of the fluid tank.

### BRIEF SUMMARY OF THE INVENTION

An embodiment of the disclosure meets the needs presented above by generally comprising a vacuum manifold that includes a body defining an interior space of the vacuum manifold, an input tube and a plurality of output tubes. The input tube is coupled to the body and is in fluid communication with the interior space. Each of the plurality of output tubes is coupled to the body and is in fluid communication with the interior space. In this way the input tube is in fluid communication with each of the plurality of output tubes. The vacuum manifold is comprised of an oil resistant material to resist being degraded by crude oil. Additionally, the vacuum manifold is comprised of a rigid material to resist being deformed by vacuum pressure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a vacuum manifold assembly according to an embodiment of the disclosure.

FIG. 2 is a bottom perspective view of an embodiment of the disclosure.

FIG. 3 is a cross sectional view taken along line 3-3 of FIG. 4 of an embodiment of the disclosure.

FIG. 4 is a bottom view of an embodiment of the disclosure.

FIG. 5 is a perspective in-use view of an embodiment of the disclosure.

### DETAILED DESCRIPTION OF THE INVENTION

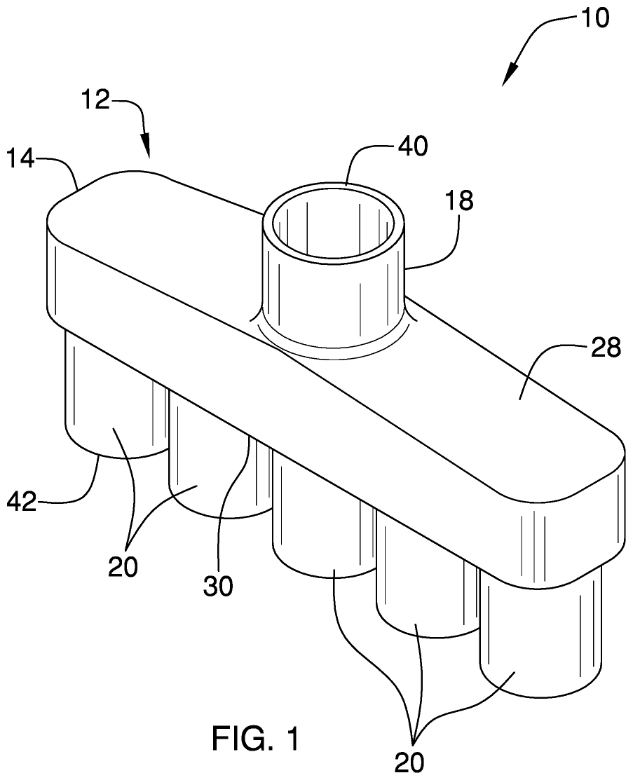

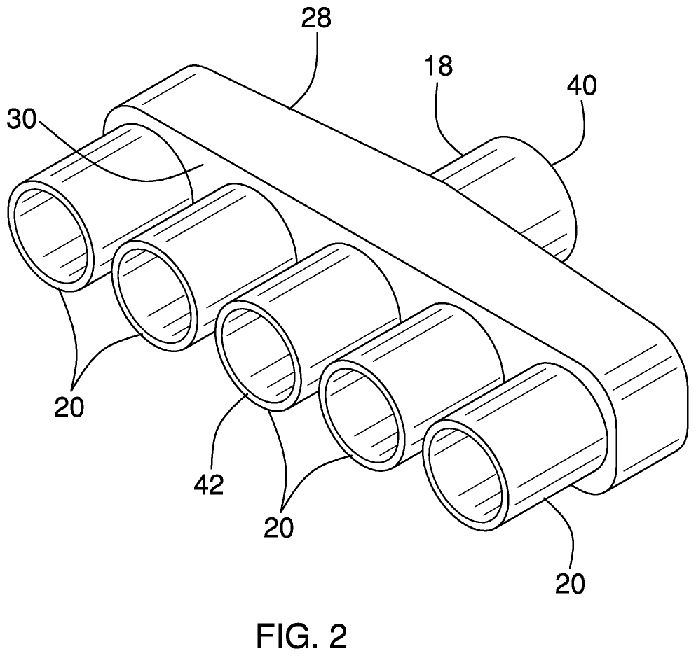

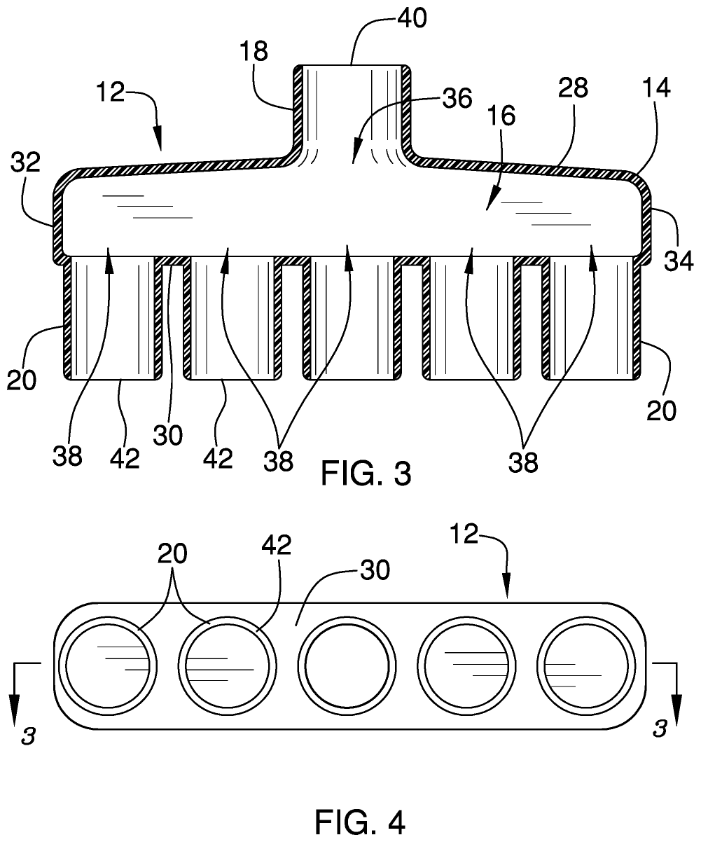

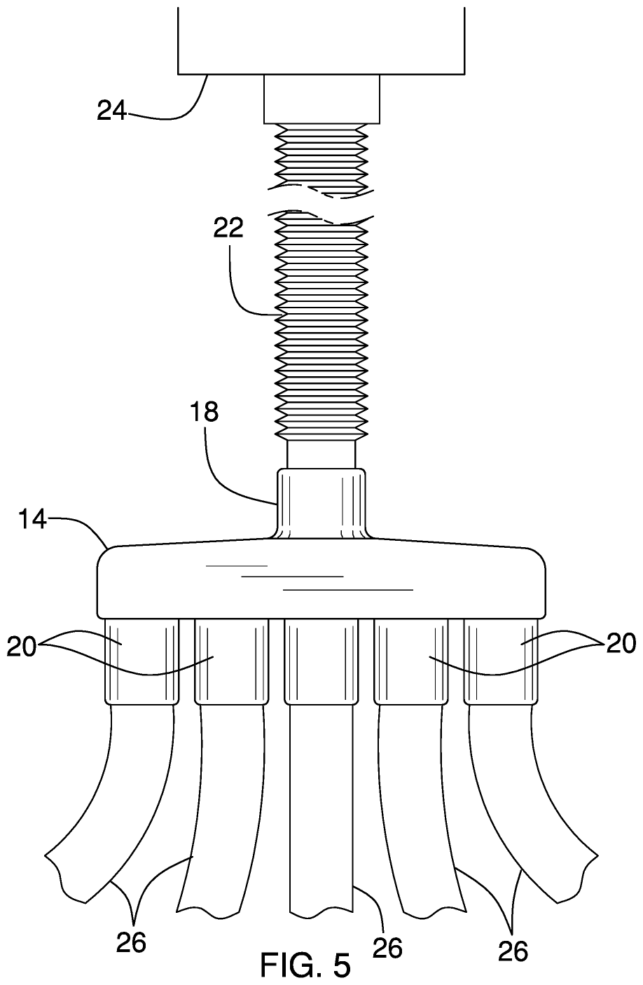

With reference now to the drawings, and in particular to FIGS. 1 through 5 thereof, a new manifold device embodying the principles and concepts of an embodiment of the disclosure and generally designated by the reference numeral 10 will be described.

As best illustrated in FIGS. 1 through 5, the vacuum manifold assembly 10 generally comprises a vacuum manifold 12 that includes a body 14 defining an interior space 16 of the vacuum manifold 12, an input tube 18 and a plurality of output tubes 20. The input tube 18 is coupled to the body 14 and is in fluid communication with the interior space 16. Additionally, each of the plurality of output tubes is coupled to the body 14 and is in fluid communication with the interior space 16. Thus, input tube is in fluid communication with each of the plurality of output tubes.

The input tube 18 has a diameter of at least 2.0 inches thereby facilitating the input tube 18 to engage a suction hose 22 of a vacuum pump 24. Moreover, the vacuum pump 24 may be a fluid vacuum pump of the type that is commonly employed on an oilfield vacuum truck. In this way the vacuum manifold 12 can be employed in oilfield fluid recovery operations. Each of the plurality of output tubes 20 has a diameter of at least 2.0 inches thereby facilitating each of the plurality of output tubes 20 to engage a vacuum hose 26 for the vacuum pump 24. In this way the vacuum manifold 12 facilitates a plurality of workers to vacuum fluids in the oilfield with a single vacuum pump. Thus, the vacuum manifold 12 increases productivity in oilfield fluid recovery operations.

The body 14 has a top wall 28 and a bottom wall 30, and the body 14 is elongated along an axis extending through a first end 32 and a second end 34 of the body 14. The top wall 28 has an input opening 36 extending into the interior space 16 of the body 14. Additionally, the input opening 36 is centrally positioned on the top wall 28. The bottom wall 30 has a plurality of output openings 38 each extending into the interior space 16 of the body 14. The plurality of output openings 38 is spaced apart from each other and is distributed along the axis extending between the first end 32 and the second end 34 of the body 14.

The input tube 18 extends away from the top wall 28 and the input tube 18 is aligned with the input opening 36. The input tube 18 has a distal end 40 with respect to the top wall 28 to insertably receive the suction hose 22. Each of the plurality of output tubes 20 is positioned on the bottom wall 30 of the body 14 and each of the output tubes 20 is aligned with a respective one of the output openings 38. Each of the plurality of output tubes 20 has a distal end 42 with respect to the bottom wall 30. Moreover, the distal end 42 of each of the plurality of output tubes 20 insertably receives the vacuum hose 26 that is used by each worker. In this way a plurality of vacuum hoses 26 can be fluidly coupled to the vacuum pump 24. Moreover, the plurality of vacuum hoses 26 facilitates the vacuum pump 24 to simultaneously recover a variety of different fluids or materials.

The vacuum manifold 12 is comprised of an oil resistant material such that the vacuum manifold 12 resists being degraded by crude oil. The oil resistant material may comprise polyurethane, natural rubber, polytetrafluroethylene or any other material known for exceptional resistance to petroleum oils, solvents and other hazardous fluids likely to be encountered in oilfield fluid recovery operations. Additionally, the vacuum manifold 12 is comprised of a rigid material to resist being deformed by vacuum pressure.

In use, the suction hose 22 is plugged into the input tube 18 and each of the vacuum hoses 26 is plugged into the respective output tube 20. In this way each of the vacuum hoses 26 is fluidly coupled to the vacuum pump 24 for vacuuming fluids or materials. Each vacuum hose 26 can be manipulated to a worker to enhance the speed with which a reservoir of fluid can be recovered. Additionally, each of the vacuum hoses 26 can be routed to a respective reservoir of fluid or collection or materials. In this way the vacuum pump 24 can simultaneously recover a variety of fluids or materials.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vacuum manifold assembly being configured to facilitate a plurality of vacuum hoses to be fluidly coupled to a single vacuum supply hose, said assembly comprising:
a vacuum manifold comprising a body defining an interior space of said vacuum manifold, an input tube and a plurality of output tubes, said input tube being coupled to said body and being in fluid communication with said interior space, each of said plurality of output tubes being coupled to said body and being in fluid communication with said interior space thereby facilitating fluid communication between said input tube and each of said plurality of output tubes, said vacuum manifold being comprised of an oil resistant material wherein said vacuum manifold is configured to resist being degraded by crude oil, said vacuum manifold being comprised of a rigid material wherein said vacuum manifold is configured to resist being deformed by vacuum pressure.

2. The assembly according to claim 1, wherein said input tube has a diameter of at least 2.0 inches thereby facilitating said input tube to engage a suction hose of a vacuum pump wherein said vacuum manifold is configured to be employed in oilfield fluid recovery operations.

3. The assembly according to claim 1, wherein each of said plurality of output tubes has a diameter of at least 2.0 inches thereby facilitating each of said plurality of output tubes to engage a vacuum hose for the vacuum pump wherein said vacuum manifold is configured to facilitate a plurality of workers to vacuum fluids in the oilfield with a single vacuum pump.

4. The assembly according to claim 1, wherein said body has a top wall and a bottom wall, said body being elongated along an axis extending through a first end and a second end of said body, said top wall having an input opening extending into said interior space of said body, said input opening being centrally positioned on said top wall, said bottom wall having a plurality of output openings each extending into said interior space of said body, said plurality of output openings being spaced apart from each other and being distributed along said axis extending between said first end and said second end of said body.

5. The assembly according to claim 4, wherein said input tube extends away from said top wall having said input tube being aligned with said input opening, said input tube having a distal end with respect to said top wall wherein said distal end is configured to insertably receive the suction hose.

6. The assembly according to claim 4, wherein each of said plurality of output tubes is positioned on said bottom wall of said body, each of said output tubes being aligned with a respective one of said output openings, each of said plurality of output tubes having a distal end with respect to said bottom wall wherein said distal end of each of said plurality of output tubes is configured to insertably receive the vacuum hose being used by each worker.

7. A vacuum manifold assembly being configured to facilitate a plurality of vacuum hoses to be fluidly coupled to a single vacuum supply hose, said assembly comprising:
a vacuum manifold comprising a body defining an interior space of said vacuum manifold, an input tube and a plurality of output tubes, said input being coupled to said body and being in fluid communication with said interior space, each of said plurality of outputs being coupled to said body and being in fluid communication with said interior space thereby facilitating fluid communication between said input and each of said plurality of outputs, said input tube having a diameter of at least 2.0 inches thereby facilitating said input tube to engage a suction hose of a vacuum pump wherein said vacuum manifold is configured to be employed in oilfield fluid recovery operations, each of said plurality of output tubes having a diameter of at least 2.0 inches thereby facilitating each of said plurality of output tubes to engage a vacuum hose for the vacuum pump wherein said vacuum manifold is configured to facilitate a plurality of workers to vacuum fluids in the oilfield with a single vacuum pump, said body having a top wall and a bottom wall, said body being elongated along an axis extending through a first end and a second end of said body, said top wall having an input opening extending into said interior space of said body, said input opening being centrally positioned on said top wall, said bottom wall having a plurality of output openings each extending into said interior space of said body, said plurality of output openings being spaced apart from each other and being distributed along said axis extending between said first end and said second end of said body, said input tube extending away from said top wall having said input tube being aligned with said input opening, said input tube having a distal end with respect to said top wall wherein said distal end is configured to insertably receive the suction hose, each of said plurality of output tubes being positioned on said bottom wall of said body, each of said output tubes being aligned with a respective one of said output openings, each of said plurality of output tubes having a distal end with respect to said bottom wall wherein said distal end of each of said plurality of output tubes is configured to insertably receive the vacuum hose being used by each worker, said vacuum manifold being comprised of an oil resistant material wherein said vacuum manifold is configured to resist being degraded by crude oil, said vacuum manifold being comprised of a rigid material wherein said vacuum manifold is configured to resist being deformed by vacuum pressure.
